(19) United States
(12) Patent Application Publication
(10) Pub. No.: US 2025/0089723 A1
(43) Pub. Date: Mar. 20, 2025

(54) BIOCONTROL AGENT AND METHOD FOR REDUCING THE OCCURRENCE AND IMPACTS OF APHANOMYCES EUTEICHES

(71) Applicant: DANSTAR FERMENT AG, Zug (CH)

(72) Inventor: Matthew KRAUSE, Perinton, NY (US)

(21) Appl. No.: 18/291,944

(22) PCT Filed: Jul. 29, 2022
(86) PCT No.: PCT/IB2022/057093

§ 371 Date: Jan. 25, 2024

Related U.S. Application Data
(60) Provisional application No. 63/229,228, filed on Aug. 4, 2021.

(51) Int. Cl. A01N 63/28; A01P 3/00

(52) U.S. Cl. CPC A01N 63/28; A01P 3/00

(57) ABSTRACT

The present disclosure provides a method for controlling Aphanomyces euteiches comprising the use of a strain of Streptomyces sp.

The present application claims priority from U.S. provisional application 63/229,228 filed Aug. 4, 2021.

### TECHNOLOGICAL FIELD

The present disclosure relates to a biological control agent for reducing the occurrence and impacts or for controlling root rot of plants such as root rot caused by the fungus Aphanomyces euteiches.

### BACKGROUND

Legumes are very important to agriculture as they fix nitrogen in association with rhizobia, thereby reducing the need for fertilizer inputs. They are valued worldwide as a sustainable and inexpensive meat alternative and are considered the second most important food source after cereals. However, many pathogens cause significant yield losses in legumes. Soilborne oomycete pathogens attack roots of legumes, limit nutrient uptake and cause the damping-off and/or root rot disease complex which results in plant death.

At present, Aphanomyces root rot (ARR) is one of the major limitations to several legume production, such as pea, lentil, fava bean and alfalfa production worldwide with very few means of treatments. It can infect the host plant at any time throughout the growing season. This disease is caused by Aphanomyces euteiches Drechs. (A. euteiches), which is distinguished from most other soil-borne pathogens by the formation of thick-walled oospores. These oospores are able to remain dormant for several years, even without the presence of the host. It has been reported in most legume, such as lentil and pea growing areas of North America, northern Europe, Australia, New Zealand and Japan. It can cause severe root damage, wilting, and considerable yield losses under wet soil conditions.

There are currently no efficient fungicides or other treatments available for the control of this pathogen. Indeed, traditional disease management strategies, such as crop rotations, cannot fully prevent ARR under conditions conducive for the disease, due to the longevity of the pathogen oospores, which can infect field legumes, such as lentil and pea plants at any growth stage.

Alternative strategies such as biological control strategies have been studied and developed to fight against this pathogen. The use of Bacillus and Paenibacillus and Pseudomonas strains were reported to control A. euteiches. Accordingly, there is thus a need to for developing new, alternative plant protection agents effective against A. euteiches.

### BRIEF SUMMARY

The present disclosure relates to the use of microorganisms of the species Streptomyces griseoviridis which have shown to display antagonistic effects against A. euteiches.

In an embodiment, the present disclosure relates to a method or a use for protecting a plant from a pathogen Aphanomyces euteiches or for inhibiting the development of the pathogen A. euteiches comprising the steps of contacting the pathogen, the plant or plant part during a stage of the growth of said plant, the soil surrounding the plant or a seed of said plant with a strain of Streptomyces griseoviridis which has suppressive activity against A. euteiches. The present disclosure further provides a use of S. griseoviridis for protecting a plant from Aphanomyces euteiches or for inhibiting the development of A. euteiches.

In the above-described method and use, the strain of S. griseoviridis is the S. griseoviridis strain K61 (deposited under accession number DSM 7206). In a further embodiment, the plant is a legume plant such as pea, lentil, fava bean or alfalfa and the concentration of said S. griseoviridis is between about 10² to about 10¹¹ CFU/g or ml of carrier.

### FIGURES

Having thus generally described the nature of the invention, reference will now be made to the accompanying drawings, showing by way of illustration, a preferred embodiment thereof, and in which:

FIG. 1 illustrates PDA plates after 51-54 hours of incubation with A. euteiches (small circles). Biological and chemical agents (in the center) were added to the plates 48 hours prior to introducing A. euteiches.

FIG. 2 illustrates the zone of inhibition (ZOI) between the edge of the streaks and the pathogen, measured after 51-54 hours of incubation. All values are expressed as averages where n=3 for INTEGO® Solo and n=6 for Streptomyces griseoviridis K61 tratment. Error bars represent standard deviation and different letters indicate a significant difference between treatments (Tukey comparison; α=0.01).

### DETAILED DESCRIPTION

The present disclosure provides a biological control agent and method for inhibiting the development of A. euteiches or for controlling Aphanomyces root rot in plants. The present disclosure is particularly directed to Streptomyces griseoviridis that is effective in controlling the soil-borne oomycete A. euteiches in legume fields, such as lentils or peas. More particularly, it has been demonstrated that Streptomyces griseoviridis strain K61 exhibits pronounced antagonist effects against A. euteiches. Accordingly, Streptomyces griseoviridis strain K61 is herewith provided as a biocontrol agent suitable for use against Aphanomyces root rot in legume fields, such as lentils or pea.

As used herein, “biological control” is defined as control of a pathogen and/or insect and/or an acarid and/or a nematode by the use of a second organism. Known mechanisms of biological control include bacteria that control root rot by out-competing fungi for space or nutrients on the surface of the root. “Biological control agent” as used herein may also encompass microorganisms having a beneficial effect on plant health, growth, vigor, stress response or yield. Application routes include spray application soil application and seed treatment.

By “inhibiting” or ‘inhibit” the development of a fungal pathogen means the ability of the biological control agent to retard, stabilize, reverse, slow or delay progression of an infection by the fungal pathogen. In other words, these terms are used herein to mean reduce the growth and/or development of fungi compared to where inhibiting biocontrol agent is not present.

The present disclosure provides an alternative for inhibiting the development or colonization, treating and controlling Aphanomyces root rot in legume fields, such as lentils or peas. The biological control agent used in the present disclosure is known as Streptomyces griseoviridis strain K61 (or also referred to as Streptomyces sp. K61) (which can be isolated from the product Mycostop®, Lallemand). More particularly, Streptomyces griseoviridis K61 was deposited on 8 Aug. 1992 according to the Budapest Treaty under accession number DSM 7206 at the

Deutsche Sammlung von Mikroorganismem und Zellkulturen GmbH (DSM) (Inhoffenstr. 7B, D-38124 Braunschweig, Germany).

The antagonistic activity or the suppressive activity of Streptomyces sp. K61 against A. euteiches may be determined using the dual-culture technique. The bacterial strain is streaked down the centers of plates comprising a medium which will support the growth of A. euteiches. After incubation of Streptomyces sp. K61, a mycelial plug of A. euteiches from a culture grown on potato dextrose agar is placed on both sides of the streaked line of each dish containing the bacterial streaks. The plates are incubated according to a required time and temperature and the inhibitory effect of the bacterial strain is determined by measuring the inhibition zone of mycelial growth. The inhibitory effect is scored as positive where the A. euteiches growth stops on or before the bacterial streak line.

Streptomyces griseoviridis strain K61 of the present disclosure is known and can be cultivated and caused to sporulate using methods well known in the art. Harvesting of spores is further conducted using also methods well known in the art. The spore material is then dried by a suitable process such as air drying, freeze drying or desiccation with a suitable desiccant and can be reformulated by addition of inert filler to provide a suitable number of spores per unit amount of product.

The bacteria may be utilized in the form of cultures, such as a suspension in a whole broth culture, to prepare appropriate compositions for ground treatment, plant treatment, soil and/or growing media treatment, or seed treatment.

The compositions containing the bacteria as the sole active ingredient, or as a combination with one or more other active ingredients, are prepared in known manner. Usually, the strain (e.g. the spores) is (are) formulated with a carrier in a concentration of between 1×10² and about 1×10¹¹ spores or CFU/g of carrier. The carrier used in the context of the present disclosure is an “agriculturally acceptable carrier” which includes any liquid or solid carrier to which the bacteria of the present disclosure can be added and that is not harmful to the bacteria of the present disclosure or the plants to which it is being applied. An agriculturally acceptable carrier is any liquid or solid that can be combined with the S. griseoviridis of the present disclosure and that assists in the application of the S. griseoviridis strain of the present disclosure to the soil so that the S. griseoviridis strain of the present disclosure grow and colonize the soil and roots of field peas. Non-limiting examples of agriculturally acceptable carriers include talc, starch, sucrose, lactose, and other carbohydrates, polysaccharides, milk/skim milk, cellulose, water, a buffered solution, methylcellulose, clay, sand, peat, vermiculite, diatomaceous earth, a cereal grain flour meal, cotton meal, rice, or seeds, and liquid media. A carrier can also be a polymeric porous material, such as polyvinyl alcohol (PVA), polyethylene glycol (PEG), polyacrylic acid (PAA), poly(lactic acid) (PLA), poly(glycolic acid) (PGA), copolymer of poly(lactic-co-glycolic acid) (PLGA), poly(c-caprolactic acid) (PCLA), poly(f3-hydroxybutyric acid), poly(f3-hydroxyvaleric acid), polydioxanone, poly(ethylene oxide), poly(malic acid), poly(tartronic acid), polyphosphazene, polyethylene (PE), polystyrene (PS), agar (alginate) or other polysaccharides, gelatin, or combinations thereof. The carrier should not kill the bacteria of the present disclosure. Also, the carrier should release the bacteria of the present disclosure into the soil after application to the soil or onto plants after application onto the plants. Such release of the bacteria may occur after a period of rain or irrigation or other type of application of water to the soil and/or plant. Any carrier that permits the bacteria of the present disclosure to be delivered to the soil and/or target plant in a manner such that the bacteria remains viable may be employed in the composition so long as the carrier does not harm native plants and crops.

The S. griseoviridis of the present disclosure can be combined with other biocontrol agents and applied sequentially or together. Further, the S. griseoviridis of the present disclosure may also be used in combination with biologically compatible pesticidal active agents as for example, herbicides, nematocides, fungicides, insecticides, and the like. They can also be used in combination with plant growth affecting substances, such as fertilizers, plant growth regulators, and the like, provided that such compounds or substances are biologically compatible.

The active constituents are used in a concentration sufficient to inhibit targeted plant pathogen development when applied to the plants. According to the present disclosure, typical concentrations are those higher than 1×10² CFU (“Colony Forming Unit”)/g or ml of carrier. Preferred concentrations range from about 1×10⁴ to about 1×10⁹ CFU/g or ml of carrier, such as the concentrations ranging from 1×10⁶ to 1×10⁸ CFU/g or ml of carrier.

The S. griseoviridis of the present disclosure may be applied to the plants using any known conventional methods such as dusting, injecting, rubbing, rolling, dipping, drenching, spraying, or brushing, or any other appropriate technique which does not injury the plants to be treated.

One can apply the S. griseoviridis of the present disclosure or the composition onto seeds (e.g. pea Pisum sativum L. seeds) as a seed coating prior to planting and then drill the seed into the soil or broadcast the seed. A preferred method for coating the seeds is to combine the bacterial strain with a biologically non-interfering liquid carrier for application onto the seeds. A carrier shall be deemed “biologically non-interfering” if it does not prevent the bacterial strains from growing.

The word “comprising” in the claims may be replaced by “consisting essentially of” or with “consisting of,” according to standard practice in patent law.

The following example serves to further describe and define the invention and is not intended to limit the invention in any way.

### EXAMPLE 1

The objective of this experiment was to perform an in vitro bioassay on agar plates with Streptomyces griseoviridis K61 to evaluate whether the strain can suppress the growth of Aphanomyces euteiches. Therefore, the antagonistic activity of K61 was determined against A. euteiches.

### Materials and Methods

A. euteiches was subcultured onto potato dextrose agar (PDA) plates and incubated in the dark for 48-72 hours at 23° C. Streptomyces sp. K61 was isolated from MYCOSTOP®. The product was resuspended in water and streaked onto TSA plates followed by incubation at 28° C. for 48 hours. INTEGO® Solo is a seed-applied fungicide that contains the active ingredient ethaboxam (34.2% by weight) and is the only chemical treatment that is registered to suppress A. euteiches. Once all the cultures and materials were prepared, the following protocol was completed.

Briefly, a loopful of Streptomyces sp. K61 (from single colonies) was streaked down the centers of PDA plates. Two loopfuls of sterile d′H₂O or INTEGO® Solo were streaked down the centers of PDA plates (each loop starting at the opposite end) to act as negative and positive controls, respectively. All plates were inverted and incubated in the dark (28° C., 48 hours). Agar plugs of A. euteiches were placed on both sides of the streaked line for each PDA plate. Following the introduction of A. euteiches, the plates were incubated upright in the dark at 23° C. until the growth of the pathogen from each plug met in the middle of the negative controls (≈52 hours). After the incubation, the zone of inhibition (ZOI) was measured between the edges of the streak and the pathogen on each side (2 measurements per plate).

During the first incubation period, plates were maintained at 28° C. to accelerate the growth of the bacterial culture while 23° C. was used during the second incubation to provide optimal conditions for the growth of A. euteiches.

### Results

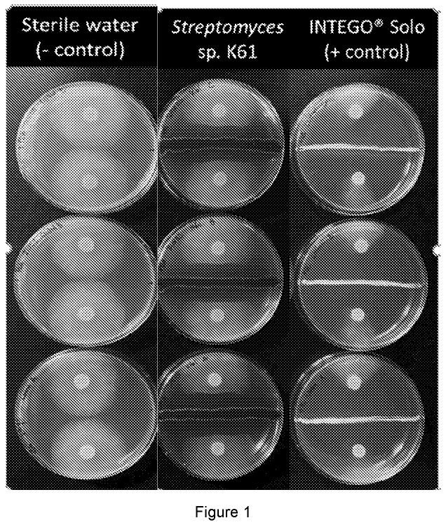

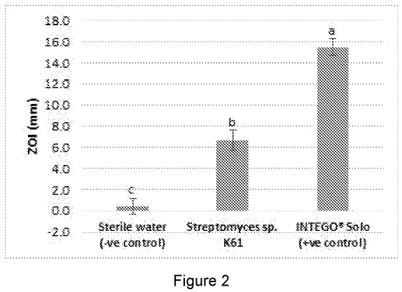

The growth of A. euteiches was suppressed by Streptomyces sp. K61 and the positive control, INTEGO® Solo on PDA plates. In a non-surprising way, A. euteiches growth was suppressed most strongly by INTEGO® Solo which was visualized clearly (FIG. 1). There was a significant difference (p<0.01) between the ZOI of Streptomyces sp. K61 and the negative control (FIG. 2).

1. A method for protecting a plant from a pathogen Aphanomyces euteiches or for inhibiting the development of the pathogen A. euteiches comprising the steps of contacting the pathogen, the plant or plant part during a stage of the growth of said plant, the soil surrounding the plant or a seed of said plant with a strain of Streptomyces griseoviridis which has suppressive activity against A. euteiches.

2. The method of claim 1, wherein the strain of S. griseoviridis is the S. griseoviridis strain K61 (deposited under accession number DSM 7206).

3. The method of claim 1, wherein the plant is a legume plant.

4. The method of claim 3, wherein the legume plant is pea, lentil, fava bean or alfalfa.

5. The method of claim 1, wherein the concentration of said S. griseoviridis is between about 10² to about 10¹¹ CFU/g or ml of carrier.

6-10. (canceled)
